(19) United States
(12) Patent Application Publication
(10) Pub. No.: US 2026/0160874 A1
(43) Pub. Date: Jun. 11, 2026

(54) PRESENCE DETECTION METHOD IMPLEMENTED INSIDE A MOTOR VEHICLE

(71) Applicant: Schaeffler Technologies AG & Co. KG, Herzogenaurach (DE)

(72) Inventors: Ihssen MASRI, Toulouse (FR); Marwa JABER, Toulouse (FR)

(21) Appl. No.: 19/127,318

(22) PCT Filed: Jan. 3, 2024
(86) PCT No.: PCT/EP2024/050057

§ 371 Date: May 5, 2025

(30) Foreign Application Priority Data
Jan. 13, 2023 (FR) FR2300331

(51) Int. Cl. G01S 13/04; G01S 7/41; G01S 13/02

(52) U.S. Cl. CPC G01S 13/04; G01S 7/41; G01S 13/0209

(57) ABSTRACT

The invention relates to a method (100) for detecting presence implemented within a motor vehicle, and using a return pulsed signal resulting from reflection from a target of a transmitted pulsed signal, the return pulsed signal and the transmitted pulsed signal each consisting of radio-frequency pulses, the presence-detecting method (100) comprising the following steps:
a/ generating (101) sampled data (I, Q) relative to the return pulsed signal;
b/ for each of a plurality of successive time intervals (ΔTⱼ), extracting (102) sampled data located in said time interval (ΔTⱼ), and relating to sampling times for which the separation from a transmission time of a respective pulse of the transmitted pulsed signal (SE) is less than a predetermined threshold;
c/ for each of said successive time intervals (ΔTⱼ), and using the values extracted in step b/, computing (103) a value (φ(ΔTⱼ)) of a phase shift between the return pulsed signal and the transmitted pulsed signal; then
d/ using the phase-shift values (φ(ΔTⱼ)) to identify the presence or absence of a user.

### TECHNICAL FIELD

The invention relates to the field of motor vehicles and more particularly to a presence-detecting method, implemented within a motor vehicle to detect the presence of a user in the immediate vicinity of an element such as a door handle.

### PRIOR ART

Presence-detecting devices implemented within a motor vehicle are known in the prior art, these devices being based on the use of an electrode coupled with capacitive measurements.

One drawback of solutions based on capacitive technology is that they can be vulnerable to disturbances, such as rain drops, due to the exterior environment.

One objective of the invention is to provide a solution allowing, within a motor vehicle, implementation of presence detection that is robust to disturbances such as rain drops, while maintaining a low bulk and complexity.

### SUMMARY OF THE INVENTION

This objective is achieved with a method for detecting presence implemented within a motor vehicle, and using a return pulsed signal resulting from reflection from a target of a transmitted pulsed signal, the return pulsed signal and the transmitted pulsed signal each consisting of radio-frequency pulses.

The presence-detecting method comprises the following steps:
a/ generating sampled data relative to the return pulsed signal;
b/ for each of a plurality of successive time intervals, extracting sampled data located in said time interval, and relating to sampling times for which the separation from a transmission time of a respective pulse of the transmitted pulsed signal is less than a predetermined threshold;
c/ for each of said successive time intervals, and using the values extracted in step b/, computing a value of a phase shift between the return pulsed signal and the transmitted pulsed signal; then
d/ using the phase-shift values to identify the presence or absence of a user.

Throughout this text, the term “radio-frequency” relates to a signal the frequency of the carrier of which is between 3 kHz and 300 GHz. Preferably, the frequency of the carrier is, in the invention, between 5 GHz and 20 GHZ, and more preferably between 5 GHz and 10 GHz.

In use, the target is for example the hand of a user.

The data sampled from the return pulsed signal for example correspond to sampled values of a phase component and of a quadrature component of the return pulsed signal.

The method according to the invention may comprise the steps of transmitting the transmitted pulsed signal and receiving the return pulsed signal.

One of the ideas behind the invention consists in detecting the presence or absence of a user, via gesture detection. Detection of a gesture indicates the presence of a user, and vice versa.

The gesture detection is based on a radar technology, this making it robust to disturbances such as rain drops while maintaining a low bulk and complexity.

In a manner known per se, gesture detection by means of radar technology is based on transmission of a radio-frequency signal in the direction of a reception area, and reception of a return signal resulting from reflection of the transmitted radio-frequency signal, from at least one target located in the reception area.

The most economical systems are based on simple time-of-flight calculations: for each of a plurality of sampling times, the time taken by the radio-frequency signal to make the round trip between a transceiver and the target is determined. This time indicates a current distance to the target. However, one drawback is that the accuracy with which the current distance to the target is determined is limited by the sampling frequency. Now, this sampling frequency cannot be increased indefinitely without leading to borderline aliasing conditions (Shannon criterion). Thus, typical sampling-frequency values are 1 GHz, i.e. a period of one nanosecond. This corresponds to an accuracy of only 15 cm in the determination of the current distance to the target. This accuracy is insufficient in the context of presence detection, based on detection or not of a gesture in the immediate vicinity of a radar module, i.e. often at less than 10 cm from a radar module.

The invention therefore proposes, in order to overcome this limitation, rather than using phase-shift measurements, to use variations in this phase shift indicating the presence or absence of a gesture.

Furthermore, in order to spatially circumscribe the presence detection, the invention makes provision to use only data relating to sampling times for which the separation from a transmission time of a respective pulse of the transmitted pulsed signal is less than a predetermined threshold. Said predetermined threshold is a threshold in units of time, easily convertible into a threshold in units of distance bounding the maximum range of the presence detection. It is thus ensured that the presence detection indeed corresponds to detection of a presence in the immediate vicinity of a transceiver module transmitting the transmitted pulsed signal and receiving the return pulsed signal.

Advantageously, step d/ comprises the following sub-steps:
d-i/ for each of said successive time intervals, computing a value of a derivative of the phase shift;
d-ii/ comparing said value of the derivative of the phase shift and the limits of at least one predetermined interval;
d-iii/ for a time window of predetermined width, framing a plurality of said successive time intervals, computing a final value of a counter, the value taken by the counter being incremented by at least one unit each time the value of the derivative of the phase shift lies within the at least one predetermined interval;
d-iv/ comparing the final value of the counter and a counter threshold, and generating a high or low response value depending on whether the final value of the counter is less than or greater than the counter threshold;
d-v/ applying successive shifts to the time window, and carrying out a new iteration of steps d-iii/ and d-iv/, so as to construct a response signal formed by the sequence of high or low response values; and
d-vi/ using the response signal to identify the presence or absence of a user.

The values of the derivative of the phase shift characterize a velocity of the target. By comparing a value of the derivative of the phase shift with the limits of at least one predetermined interval, it is verified whether a movement of the target has the velocity characteristics of an expected gesture of the user.

By using a wide time window, and a counter the value of which is incremented each time it is considered that the movement of the target has the expected velocity characteristics, the stability of a presence detection based on an analysis of the velocity of the target is ensured. This stabilization of the presence detection ensures a high robustness against noise and environmental disturbances.

By sliding the time window temporally, a binary response signal is gradually constructed, which takes a high or low value depending on whether or not a stabilized movement of the target having predetermined velocity characteristics has been detected.

This response signal is then used to identify the presence or absence of a user. For example, it is possible to generate information relative to a presence detection as soon as the response signal jumps from a low value to a high value. As a variant, the information relative to a presence detection is generated only if, furthermore, the high value is maintained for a duration greater than a predetermined threshold.

Preferably, in step d-i/, the value of the derivative of the phase shift is computed using a difference between the phase-shift value associated with the time interval in question and the phase-shift value associated with the immediately preceding time interval.

Advantageously, the successive time intervals all have the same time width ΔT and follow one another immediately pairwise.

Preferably, the successive shifts of step d-v/ define a series of positions of the time window, which are temporally distributed so as to have a regular distribution pitch.

The distribution pitch of the positions of the time window is advantageously equal to N*ΔT, with N an integer greater than or equal to unity.

Preferably, the width of the time window is between 50 and 200 times the distribution pitch of the positions of said window.

The method may also comprise a step of using the information relative to the presence or absence of a user to generate a command to lock or unlock a hatch of the vehicle.

Preferably, the transmitted pulsed signal is a UWB signal.

The invention also covers a system comprising:
a radar module, comprising an electrical oscillator, at least one radio-frequency antenna, at least one mixer and at least one analog-to-digital converter, and configured to transmit the transmitted pulsed signal, receive the return pulsed signal, and generate the sampled data relative to the return pulsed signal; and
a computing unit, comprising at least one memory and at least one processor, the at least one memory comprising program code instructions that, when they are executed by the at least one processor, configure said processor to implement step b/ and the steps following step b/ of the method according to the invention.

The system may further comprise a door handle incorporating the radar module.

The invention also relates to a computer program product comprising instructions for implementing step b/ and the steps following step b/ of the method according to the invention when the program is executed by a processor.

### DESCRIPTION OF THE FIGURES

Other features and advantages of the invention will become more clearly apparent on reading the following description. This description is purely illustrative and should be read with reference to the appended drawings, in which:

FIG. 1 schematically illustrates the steps of a method according to the invention;

FIG. 2 schematically illustrates a system according to the invention;

FIG. 3 schematically illustrates sampled data relative to the return pulsed signal;

FIG. 4 illustrates one example of the variation, as a function of time, in the value of the phase shift between the return pulsed signal and the transmitted pulsed signal;

FIG. 5 illustrates one example of the variation, as a function of time, in the derivative of the phase shift between the return pulsed signal and the transmitted pulsed signal;

FIG. 6 schematically illustrates the time window of predetermined width used in the method according to the invention;

FIG. 7 shows one example of the variation, as a function of time, in the final counter value, the counter threshold and the response signal constructed using the final counter values.

### DETAILED DESCRIPTION OF AT LEAST ONE EMBODIMENT

One particular example of a method 100 and system 200 according to the invention is described below.

The method according to the invention is implemented within a motor vehicle. Its purpose is to detect the presence of a user in the immediate vicinity of an element such as a door handle or a vertical structural pillar (B-pillar for example).

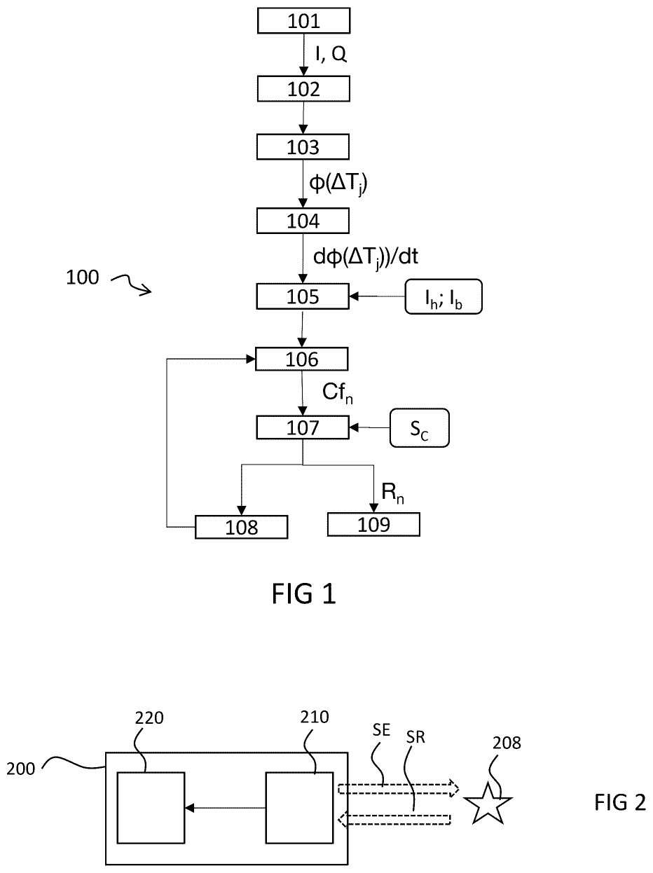

The system 200 according to the invention is schematically illustrated in FIG. 2.

The system 200 comprises:
a radar module 210; and
a computing unit 220.

The radar module 210 comprises, in a manner known per se, at least one electrical oscillator, at least one radio-frequency antenna, at least one mixer and at least one analog-to-digital converter.

It is configured to:
transmit a transmitted pulsed signal SE, in the direction of a target 208 located in use outside the vehicle;
receive a return pulsed signal SR, corresponding to reflection (or backscatter) of the transmitted pulsed signal SE from the target 208;
carry out phase mixing and quadrature mixing between the return pulsed signal and the transmitted pulsed signal or its carrier, so as to generate data I(t) relative to a phase component of the return pulsed signal SR and data Q(t) relative to a quadrature component of the return pulsed signal SR; and
carry out a temporal sampling upstream or downstream of the mixing, with a view to providing sampled data relative to the return pulsed signal SR, here sampled data relative to the phase component I(t) and to the quadrature component Q(t) of the return pulsed signal SR.

In use, the radar module 210 is for example placed inside a door handle, or in a vertical structural pillar (B-pillar for example).

The transmitted pulsed signal SE is a radio-frequency signal, and preferably a UWB radio-frequency signal.

Throughout this text, the term UWB (which stands for Ultra-Wide Band) refers to a radio-frequency signal of low energy and large spectral width. In particular, a UWB radio-frequency signal is defined by a ratio of bandwidth to central frequency greater than or equal to 20%, or by a bandwidth of 250 MHz or more.

The return pulsed signal SR results from reflection, from a target, of the transmitted pulsed signal. It is therefore also a radio-frequency signal, for example a UWB radio-frequency signal, but the characteristics of which, such as its phase, oscillation frequency, and amplitude, have been modified by the interaction with the target.

The computing unit 220 comprises at least one memory and at least one processor, the at least one memory comprising program code instructions that, when they are executed by the at least one processor, configure said processor to implement steps of the method such as described below. The computing unit 220 may be arranged remotely from the radar module 210.

The computing unit 620 is configured to deliver as output information relative to the presence or absence of a user.

The method 100 according to the invention is illustrated in FIG. 1. It comprises the steps detailed below.

### Step 101;

The method according to the invention firstly comprises a step 101 of generating sampled data relative to the return pulsed signal SR.

The sampling preferably has a sampling pitch of between 0.8 ns and 2 ns, for example 1 ns.

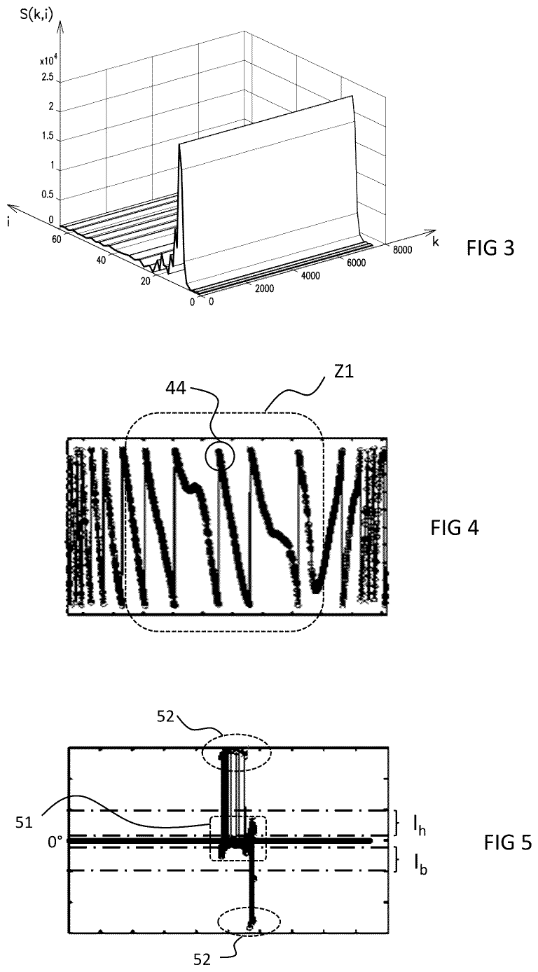

FIG. 3 schematically illustrates sampled data relative to the return pulsed signal. They take matrix form. One axis of the matrix corresponds to a pulse index k of the transmitted pulsed signal. One axis of the matrix corresponds to an index i of a sampling time, the value of the index being reset to zero on each new pulse of the transmitted pulsed signal. A last axis of the matrix corresponds to the value S(k,i) taken by the sampled datum, each value being associated with one pulse index k of the transmitted pulsed signal and with one sampling-time index i.

The values S(k,i) preferably correspond to the values of the phase component I(t) of the return pulsed signal SR, and to the values of the quadrature component Q(t) of the return pulsed signal SR.

The radar module 210 is configured to store the data S(k,i), and then to send them in packets to the computing unit 620. They are sent at regular intervals ΔTⱼ.

The time intervals ΔTⱼ each have the same time width, and follow one another directly. This time width is advantageously between 0.8 ms and 1.2 ms, and for example equal to 1 ms.

### Step 102:

The method then comprises, for each time interval ΔTⱼ, a step of extracting data S(k,i) located in said time interval ΔTⱼ, and relating to sampling times for which the separation from a transmission time of a respective pulse of the transmitted pulsed signal SE is less than a predetermined threshold EC1.

The predetermined threshold EC1 defines a maximum temporal separation from a transmission time of a respective pulse of the transmitted pulsed signal SE. It therefore corresponds to a maximum distance from the radar module 610, beyond which the return pulsed signal SR is no longer exploited.

For example, a threshold is set at EC1=2 ns. This amounts to considering only the return pulsed signal coming from a target located at 30 cm or less from the radar module 610.

This ensures that only the most relevant data are selected in the context of detection of presence in the immediate vicinity of the radar module 6100.

### Step 103:

The method then comprises, for each time interval ΔTⱼ, a step of computing a value φ(ΔTⱼ) of the phase shift between the return pulsed signal SR and the transmitted pulsed signal SE.

Said phase-shift value φ(ΔTⱼ) is obtained using the values S(k,i) extracted in step 102, and with φ(t)=arctan(Q(t)/I(t)).

Preferably, the values S(k,i) relative to various pulses k, and potentially to various sampling times i, are combined together in the form of an arithmetic mean for the computation of φ(ΔTⱼ).

FIG. 4 illustrates one example of the variation, as a function of time, in the value φ(ΔTⱼ) of the phase shift between the return pulsed signal and the transmitted pulsed signal. The x-axis is time, and the y-axis is an angle that here varies between −180° and +180°. In FIG. 4, the time axis extends over a duration of about 1 second.

Zones with rapid variations in the phase shift (to the left and to the right in FIG. 4), and a zone Z1 with a slow variation in the phase shift (in the center in the figure) may be seen in FIG. 4.

The zones with rapid variations in the phase shift correspond roughly to the times at which the detected movement is a spurious, relatively erratic movement.

Conversely, the zone Z1 roughly corresponds to the times at which the target makes a relatively regular movement, corresponding to an approaching gesture made deliberately by a user, and indicating her or his presence.

At this stage, it is however difficult to accurately discriminate a deliberate approaching gesture from a spurious movement.

### Step 104:

The method then comprises, for each time interval ΔTⱼ, a step of computing the time derivative dφ(ΔTⱼ)/dt of the phase shift.

Preferably:

$$d φ ( Δ {T}_{i} ) / d t = ( φ ( Δ {T}_{i} ) - φ ( Δ {T}_{{j - 1}^{}} ) ) / Δ T , with Δ T the time width of the time intervals Δ {T}_{j} .$$

Since the value ΔT is a constant, it is possible to consider in the method that

$$d φ ( t ) / dt = φ ( Δ {T}_{k} ) - φ ( Δ {T}_{k - 1} ) .$$

In other words, the value of the derivative of the phase shift associated with the time interval ΔTⱼ is considered to be equal to the difference between the phase-shift value associated with the time interval ΔTⱼ in question and the phase-shift value associated with the immediately preceding time interval ΔTⱼ₋₁.

FIG. 5 illustrates one example of the variation in the derivative of the phase shift as a function of time. The x-axis is time, and the y-axis is an angle in degrees.

The following may be identified in FIG. 5:
a region 51 in which the values of the derivative of the phase shift vary, while remaining close to the value zero; and
two regions 52 in which the values of the derivative of the phase shift take high absolute values.

One of the considerations underlying the invention is that it is not possible, on the basis of FIG. 5 alone, to directly make a reliable distinction between high phase-shift values related to an erratic movement of the target, and the high phase-shift values that may be obtained even in the presence of a deliberate gesture made by the target.

These high phase-shift values, which are obtained even in the presence of a deliberate gesture, may correspond to localized but abrupt variations in phase (zones 44 in FIG. 4) that are simply related to the fact that the phase-shift values take values modulo 2*It (circular character of the phase).

### Step 105:

In a subsequent step, said value of the derivative dφ(ΔTⱼ))/dt of the phase shift is compared with the limits of at least one predetermined interval.

Here, the at least one predetermined interval comprises a low interval I_{b} and a high interval Iₕ, which together flank the value zero.

Preferably, the low interval I_{b} and the high interval Iₕ are symmetrical about the zero value of the phase-shift derivative. This amounts to comparing the absolute value of the derivative of the phase shift with the limits of at least one predetermined interval.

The fact that the current value of the derivative of the phase shift is located in the low interval I_{b} or in the high interval Iₕ indicates that the phase shift exhibits variations characteristic of a deliberate gesture. In other words, the velocity of the target is regular, and is circumscribed between a maximum velocity and minimum velocity characteristic of a deliberate gesture.

For example, Iₕ is between 0.1° and P, and I_{b} is between −0.1° and −P, with P between 5° and 30°, for example P=20°.

### Step 106:

For a time window 65 of predetermined width framing a plurality of said successive time intervals ΔTⱼ, the final value Cfₙ of a counter is computed, the value taken by the counter being incremented by at least one unit each time the value of the derivative dφ(ΔTⱼ))/dt of the phase shift lies within the at least one predetermined interval I_{b}, Iₕ.

For a time window of predetermined width, the final value of a counter Cfi is computed.

The computation of step 106 therefore uses:
a counter of predetermined initial value, preferably the value zero; and
the values of the derivative of the phase shift associated with each of the time intervals ΔTⱼ located in the time window 65.

The counter is incremented by at least one unit each time one of said values of the derivative of the phase shift is located in at least one predetermined interval I_{b}, Iₕ. In other cases, the value of the counter is not changed.

Advantageously, the counter is incremented by exactly one unit each time a value of the derivative of the phase shift is located in at least one predetermined interval I_{b}, Iₕ.

In variants, the following are used:
a plurality of intervals, which are symmetric pairwise and increasingly distant from a zero value of the derivative of the phase shift; and
an incrementation value that gradually increases as the zero value of the derivative of the phase shift is approached.

It is thus possible to make it so that the rate of increase in the value taken by the counter is proportional to the regularity of the movement of the target.

As mentioned above, two intervals flanking the value zero are used here. The value zero is excluded, in order to avoid incrementing the counter in the absence of movement of a target.

In variants, a single interval incorporating the value zero is considered. Data relative to the amplitude of the return pulsed signal are then used to ensure that the counter is not incremented in the absence of movement of a target.

### Step 107:

The final value of the counter Cfₙ is then compared with a counter threshold S_{c}, and a high or low response value Rₙ is generated depending on whether the final value of the counter Cfₙ is lower or higher than the counter threshold S_{C}. For example, S_{C} is between 10 and 15.

### Step 108:

The position of the time window is then shifted temporally by a shift value ΔF. The time window 65 thus forms a sliding window.

Steps 106 and 107 are then repeated for the new position of the time window.

The successive shifts of the time window 65 thus construct, as they are applied, a response signal formed by the sequence of response values Rₙ. The index n (see Rₙ and Cfₙ) relates to the successive positions of the time window.

FIG. 6 schematically illustrates the time window 65 of predetermined width, for four successive positions of the latter. The successive positions of the time window are regularly spaced apart pairwise, with one time interval ΔF between two successive positions of the time window.

The distribution pitch ΔF of the positions of the time window is equal to the distribution pitch ΔT of the time intervals ΔTⱼ in question, or to an integer multiple of said distribution pitch ΔT.

Advantageously, the sliding window has a time width Tw between 50 and 200 times the distribution pitch ΔF of the positions of said window.

For example, Tw=100 ms, ΔT=ms, and ΔF=1 ms.

In FIG. 6, the x-axis is time, and the y-axis is an angle. FIG. 6 also shows a curve 66 schematically representing the variation, as a function of time, in the phase shift φ(t) mentioned above.

Advantageously, the steps described above are repeated at least until a final counter value Cfₙ greater than the counter threshold S_{C} is obtained.

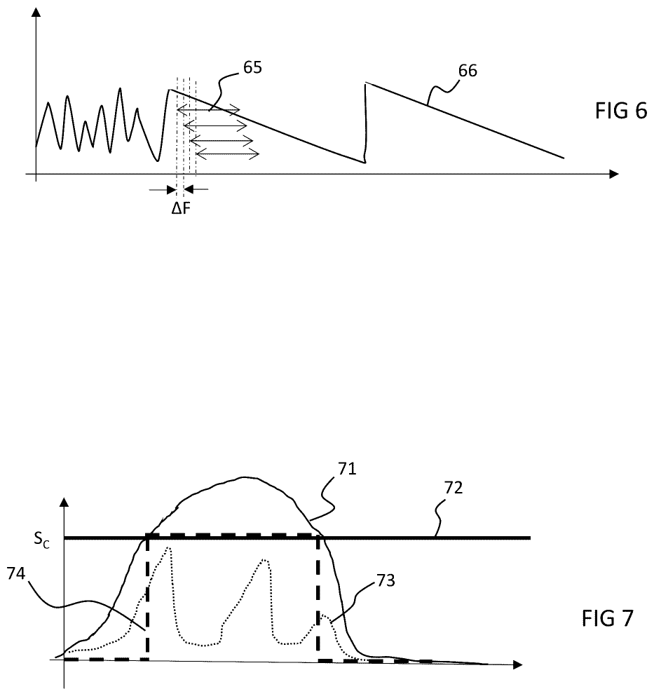

FIG. 7 further shows:
a curve 71 representing the variation in the final value of the counter as a function of the position taken by the time window, and therefore as a function of time, in the presence of a deliberate approaching gesture indicating the presence of the user;
a straight line 72 representing the value of the counter threshold S_{C};
a curve 73 representing the variation in the final value of the counter, in the presence of spurious movement; and
a template 74 representing the response signal formed by the sequence of response values Rₙ.

The template 74 initially has a low value, indicating the absence of a deliberate gesture. It flips to a high value as soon as curve 71 (final value of the counter) exceeds the straight line 72 (counter threshold S_{C}). It then returns to the low value as soon as curve 71 (final value of the counter) drops below the straight line 72 (counter threshold S_{C}) again.

The template 74 is constructed as the successive shifts of the time window are applied.

### Step 109:

Next, the response signal formed by the sequence of response values Rₙ is used to identify the presence or absence of a user.

In particular, information relative to the presence of a user may be generated as soon as the response signal passes from the low value to the high value.

As a variant, information relative to the presence of a user is generated as soon as the response signal passes from the low value to the high value, and remains there for a duration longer than or equal to a predetermined threshold.

In an optional subsequent step that has not been shown, the information relative to the presence of a user is used to generate a command to lock or unlock a hatch (depending on the initial state of the hatch) of the vehicle, the term ‘hatch’ being understood to mean a passenger-compartment door, a trunk lid, a frunk lid or a hood of the vehicle.

The steps of the method according to the invention are thus implemented repeatedly, until the response signal passes from the low value to the high value, then from the high value to the low value. This amounts to identifying the start and then the end of a gesture made in the vicinity of the radar module 210. By virtue of the use of a sliding window, the start time and the end time of the gesture are reliably determined. In particular, erroneous detection of a succession of short gestures instead of a single long gesture is avoided.

In FIG. 1, and to facilitate comprehension of the invention, step 108 of shifting the time window has been shown after step 107 of comparing the final counter value with a counter threshold. In practice, however, it is possible to carry out step 108, i.e. to initiate implementation of steps 106 and 107 relative to a following position of the time window, without waiting for steps 106 and 107 relative to a previous position of the time window to complete.

In variants, the method according to the invention may comprise a preliminary step of detection of any movement, and of then making the system 200 switch from a standby state to an active state. The detection of any movement may be based on a comparison between an amplitude of the return pulsed signal and a predetermined amplitude threshold.

In yet other variants, the sampled data generated in step 101 are corrected for a bias, or offset. This offset is in particular related to the delay introduced by the radar module 210, and to environmental noise. This offset may be measured in a preliminary calibration step.

One particular example of use of the phase-shift values φ(ΔTⱼ) to identify the presence or absence of a user has been described above. However, the invention is not limited to this example, and covers many other variants, for example not using a counter combined with a sliding window.

1. A method (100) for detecting presence implemented within a motor vehicle, and using a return pulsed signal (SR) resulting from reflection from a target (208) of a transmitted pulsed signal (SE), the return pulsed signal and the transmitted pulsed signal each consisting of radio-frequency pulses, the presence-detecting method (100) being characterized in that it comprises the following steps:
a/ generating (101) sampled data (I, Q) relative to the return pulsed signal (SR);
b/ for each of a plurality of successive time intervals (ΔTⱼ), extracting (102) sampled data located in said time interval (ΔTⱼ), and relating to sampling times for which the separation from a transmission time of a respective pulse of the transmitted pulsed signal (SE) is less than a predetermined threshold;
c/ for each of said successive time intervals (ΔTⱼ), and using the values extracted in step b/, computing (103) a value (φ(ΔTⱼ)) of a phase shift between the return pulsed signal and the transmitted pulsed signal; then
d/ using the phase-shift values (φ(ΔTⱼ)) to identify the presence or absence of a user, step d/ comprising the following sub-steps:
d-i/ for each of said successive time intervals (ΔTⱼ), computing (104) a value of a derivative (dφ(ΔTⱼ))/dt) of the phase shift;
d-ii/ comparing (105) said value of the derivative (dφ(ΔTⱼ))/dt) of the phase shift and the limits of at least one predetermined interval (I_{b}, In);
d-iii/ for a time window (65) of predetermined width framing a plurality of said successive time intervals (ΔTⱼ), computing (106) a final value (Cfₙ) of a counter, the value taken by the counter being incremented by at least one unit each time the value of the derivative (dφ(ΔTⱼ))/dt) of the phase shift lies within the at least one predetermined interval (I_{b}, Iₕ);
d-iv/ comparing (107) the final value of the counter (Cfₙ) and a counter threshold (72), and generating a high or low response value (Rₙ) depending on whether the final value of the counter (Cfₙ) is less than or greater than the counter threshold;
d-v/ applying successive shifts (108) to the time window (65), and carrying out a new iteration of steps d-iii/ and d-iv/, so as to construct a response signal (74) formed by the sequence of high or low response values (Rₙ); and
d-vi/ using (109) the response signal (74) to identify the presence or absence of a user.

2. The method (100) as claimed in claim 1, characterized in that, in step d-i/, the value of the derivative (dφ(ΔTⱼ))/dt) of the phase shift is computed using a difference between the phase-shift value (φ(Δj)) associated with the time interval (ΔTⱼ) in question and the phase-shift value (φ(ΔTⱼ₋₁)) associated with the immediately preceding time interval (ΔTⱼ₋₁).

3. The method (100) as claimed in claim 1, characterized in that the successive time intervals (ΔTⱼ) all have the same time width ΔT and follow one another immediately pairwise.

4. The method (100) as claimed in claim 3, characterized in that the successive shifts of step d-v/ define a series of positions of the time window (65), which are temporally distributed so as to have a regular distribution pitch (ΔF).

5. The method (100) as claimed in claim 4, characterized in that the distribution pitch (ΔF) of the positions of the time window (65) is equal to N*ΔT, with N an integer greater than or equal to unity.

6. The method (100) as claimed in claim 4, characterized in that the width of the time window (Tw) is between 50 and 200 times the distribution pitch (ΔF) of the positions of said window.

7. The method as claimed in claim 1, characterized in that it further comprises a step of using the information relative to the presence or absence of a user to generate a command to lock or unlock a hatch of the vehicle.

8. The method (100) as claimed in claim 1, characterized in that the transmitted pulsed signal (SE) is a UWB signal.

9. A system (200), comprising:
a radar module (210), comprising an electrical oscillator, at least one radio-frequency antenna, at least one mixer and at least one analog-to-digital converter, and configured to transmit the transmitted pulsed signal, receive the return pulsed signal, and generate the sampled data relative to the return pulsed signal (SR); and
a computing unit (220), comprising at least one memory and at least one processor, the at least one memory comprising program code instructions that, when they are executed by the at least one processor, configure said processor to implement step b/ and the steps following step b/ of the method (100) as claimed in claim 1.

10. The system (200) as claimed in claim 9, further comprising a door handle incorporating the radar module (210).

11. A computer program product comprising instructions for implementing step b/ and the steps following step b/ of the method (100) as claimed in claim 1 when the program is executed by a processor.
